(19) United States
(12) Patent Application Publication
(10) Pub. No.: US 2025/0052223 A1
(43) Pub. Date: Feb. 13, 2025

(54) Self Driven Electric Generating Apparatus

(71) Applicant: Hamilton Oghenekewe Udubra, London (GB)

(72) Inventor: Hamilton Oghenekewe Udubra, London (GB)

(73) Assignee: Hamilton Oghenekewe Udubra, London, EN (GB)

(21) Appl. No.: 18/811,689

(22) Filed: Aug. 21, 2024

(51) Int. Cl. F03B 17/06; H02N 11/00

(52) U.S. Cl. CPC F03B 17/06; H02N 11/006; F05B 2260/421; F05B 2260/422; F05B 2260/60; H02N 11/008

(57) ABSTRACT

This invention relates to electricity generating apparatus, particularly a self-driven electric generating apparatus that generates excess electrical power to meet its design load specification and a power itself. When the apparatus on, electric current is supplied to the input drive of a transmission power component from an internal power source to produce a rotational or linear motion and mechanical power to drives a converter/levers mechanism to generate an initial high input torque at low speed to drive a hydraulic pressure system to create a large force, The fluid force is converted to a mechanical motion to turn the generator drive shaft to generate electricity. In another preferred embodiment of this invention a linear output transmission power component transfers a linear motion power to a lever/string to flexible chamber or hydraulic cylinder filled with an incompressible fluid to output a high-pressure fluid to the transmission systems to generate electricity.

### CROSS-REFERENCE TO RELATED APPLICATIONS

This application claims the benefit under 35 U.S.C. 111(b) of U.S. Provisional Application Ser. No. 63/534,128 filed Aug. 23 2023, which is incorporated herein in its entirety by reference.

### DESCRIPTION

### Field of Invention

This invention relates to an apparatus for electricity generation. More particularly relates to a self-driven electric generating apparatus that produces excess power than the external load requirement and feeds back a portion of this excess power as an input power supply to the input drive motor and auxiliaries.

### Background of the Invention

Electromagnetic generators, driven by an internal combustion engine that uses fossil fuel, has been one of the most widely used methods to generate electricity worldwide, other methods include but not limited to water, wind, solar, photovoltaics and geothermal power and nuclear power etc. Each of these methods has their draw backs, ranging from waste disposer, cost, to pollution challenges.

An example of internal combustion engine driven generator is the portable gasoline driven generators commonly used as backup power to the main supply in homes, small industries and emergencies use. This form of electric power generation has some drawback, the engines which drives the electromagnetic generators produces waste and pollutant from the burning of fossil fuel-carbon monoxide, nitrogen dioxide articles and sulfur dioxide. It is believed that these pollutants apart from health hazard may have greatly contributed to ozone layer depletion and thus climate change.

In the case of Wind, and solar power while they may address the issue of pollution, they have storage and cost implication challenges when compared with gasoline driven generation hence the need to explore an alternative method.

Another motivation for this invention is to meet the need of small energy consumption for homes and cottage industries, especially in third world countries where electricity supply is a challenge.

Most third world countries go for days without electricity and when they eventually get supply, do last for some few hours. To meet the need supplemental energy, most household resorted to the use of Portable fuel driven electromagnetic generators, to extend their electricity supply for some hours. which in most cases do not meet their energy demand needs as these generators consumes a lot of gas, and are not designed to run continuously for very long hours in addition to high cost of gas. This makes the use of fossil fuel generators not sustainable for most home in the long run.

The cost of energy all over the world is on the rise due to high cost of gas and other factors, most home and small businesses are groaning under the weight of high energy cost, most homes and small cottage industries are currently looking for alternatives to help lower their energy cost. Some have added solar panel, wind and other renewable energy method to meet their energy need for home running and businesses.

There has been prior art on self-power electric generating field. Many inventors have been working on alternative methods to produce self-reliant energy source to reduce the dependance on fossil fuel. some have come out with various methods which include combining energy storage systems with mains power supply, and self-powered generating system. For example, U.S. Pat. No. 20,060,076781-A1 titled internal energy generating power source dated 22 Aug. 2006 uses an external battery to supply power to an alternator and a generator, once the system starts, the battery is disconnected. the alternator and motor combination generates electric power. the alternator supplies power to an inverter which then supply powers to external load and the motor.

While these methods of generating power are commendable, the use of expensive deep circle batteries in some self-generating power system and Inverters in particular which are known not be very efficient when subjected to inductive loads are some of the draw backs.

One of the explored technologies that addresses some of the short coming of the internal combustion and self-power generator system,

Is the preferred embodiment and other alternative embodiment of the Self-driven electric generating apparatus, an invention that uniquely combines the Electrical, Mechanical, and hydraulic power to produced a sell-power driven electric generating apparatus to produce electricity that is in excess of its external load requirement and feeds back a portion of the excess power to meet its input power needs and auxiliaries. This combination creates a drive system for electrical Power Generation; that could eliminate the use of fossil fuel when used for electrical Power Generation or reduce the use of fossil fuel when used for mechanical driven devices respectively.

While some objective of this invention may be similar to that of other inventor in the related field of invention especially in the area of powering external load and itself, the approach adopted to achieve this objective is significantly different from those adopted by others inventors.

The self-driven electric generating apparatus, uses a battery for initial start of an electric motor to drives a transmission power component to produce a rotational or linear motion to a converter/First Lever system to produce high torque at low speed. The torque produced then causes a first lever mechanism to drives the input arm of a hydraulic system to generate a large force at the output of the hydraulic system. The force generated, transmits a high-pressured Fluid to drive the output transmission systems to produce electricity that is sufficient to power an external load and also feed a portion of the power to the input electric motor and other auxiliaries. this feed back is possible via an electronic control system, details would be made clearer at detail description section of this write up.

A short form of the name Automated hydromechanical driven electric generating apparatus in the provisional application No. 63/534,128 filed Aug. 23 2023, shall be titled “self-driven electric generating apparatus.

The self-driven electric generating apparatus shall use interchangeably with the Automated hydromechanical driven electric generating apparatus without obscuring the meaning and the intent of the invention but as a short form of making the name to clearer.

### SUMMARY OF THE INVENTION

A Self-driven electric power generating apparatus, more particularly the invention relates to an electric power generator that produces excess power than the external load requirement and a portion of this excess power is fed back as an input power supply to the input drive unit electric motor and auxiliaries. This invention is distinguishable from other similar invention for the unique combination of electrical, mechanical and hydraulic system power to generate excess electrical power, to meet the external and internal design load requirement at the required torque and Speed.

Power=Torque×Speed.

An internal power source such as a battery or one or more alternative power sources selected from the group of external power source consisting of a solar panel and inverter, domestic power, and grid power provides the initial power supply to the input drive transmission power component selected from a group of transmission power components compressing; of at least one electric motor coupled to at least a compound gear train or pulley to provide a rotational motion configured to at least one converter to convert the rotational motion to an oscillatory motion to drive at least one first lever mechanism in a linkage contact to the input arm of at least one Hydraulic system to generate large hydraulic high-pressure force, The force produced transmits a high-pressure Fluid to a paddle wheel in the output transmission system to produce a mechanical power and rotational motion to drive at least one output system at least one generator shaft assembly and at least one generator to generate excess power to meet its external load design requirement, and feedback a portion of the excess Power to the input drive motors and auxiliaries.

The preferred invention and other embodiment of the preferred invention can implement with other transmission power component types selected from a group of transmission component comprising; at least one electric actuator; or at least one electro-mechanical press; or at least one electric hydraulic press; or at least one electric jack, at least one electric motor coupled at least one mechanical reducer (compound gear train) or combination of the transmission power component.

Once the system is running the internal power source is disconnected through an electronic control system and the internal power source remains on standby only to supply energy back to the system on demand; wherein included is a battery recharging unit, configured to recharge the battery while electrical power is being received from the electric generator or the external power source.

A preferred future of the present embodiment of the invention is that the at least one hydraulic system consist essentially of: at least one of input cylinder connected to at least one check valve connected to at least one output hydraulic cylinders having a higher area ratio than the input cylinder; At least one check valves in series with the recirculation tank connected between the at least one input cylinder and the at least one check valve connected to at least one output hydraulic cylinder having a larger area ratio than the input cylinder; a pressure regulators inlet is fitted inside the output cylinder or in very close proximity to be able to maintain the hydraulic system pressure and the outlet of the pressure regulator connected directly to the output transmission system input or via a manifolds as minimum to ensure it delivers the designed output force to the output transmission system.

A further future the preferred embodiment of the present invention, that ensures that output drive system continuously receive energy to maintain its momentum is to have plurality of transmission power components at the input drive unit coupled to the apparatus via a selector such that when the at least one transmission power components is at rest, others are running to ensures that at least one hydraulic system is continuously delivering high pressure fluid.

The advantage of this invention is that it simple to build, low noise, no pollution to the environment, most of the used component can be sourced in the open market, low maintenance cost, reduction in fossil fuel use and energy cost for small households.

Another future of the invention is that it could be manufactured in portable units to meet household consumption electricity needs.

A further future of the preferred embodiment of the present invention is that the input drive system and the output transmission system are not mechanically coupled at the hydraulic system outlet hence less friction is seen between the two units.

Another future of the preferred embodiment of this invention is the use at least one or plurality of transmission power components selected from a group of transmission power, components such as an electric Hydraulic Jack system, an electric actuator, an electric hydraulic press, electro mechanical press, hydraulic pump as potential energy source that could be implemented either in combination or as standalone input drive unit of the input drive system. as shall be detailed in the main description.

Another future of the embodiment of the present invention, the apparatus can be implemented using at least one electric hydraulic jack (transmission power component) as an input drive unit to subject at least one lever mechanism in series contact with at least one spring or at least one strut cylinder held in between two movable plate in contact with at least one compressible flexible chamber unit with rod end that moves within a cylinder or at least one a cylinder in which a piston and rod both filled with an incompressible fluid to compression. Thus, producing a potential energy that could be converted to kinetic energy on demand to drive the output transmission system to produce electric power.

Another future of the embodiment of the present invention that also distinguishes it for other similar invention is the use of transmission power component/converter/lever system/hydraulic system combination as input drive system in a hands-off relationship with output drive system consisting paddle/flywheel/gear/pulley arrangement and the generator drive system working seamlessly to drive a generator shaft to produce electric power.

Another future of the embodiment of the present invention is that the electric motor coupled to at least a compound gear train (mechanical reducer) as a transmission power component types, could be a Universal or (AC/DC) motor, to drives at least a converter, at least first lever mechanism, to generate high torque at low speed when compared to the generator high torque and speed to produce electricity; and the pressure regulator or spring valve at the at least one hydraulic system output maintains the hydraulic pressure to be fairly constant.

Another future of the embodiment of the present invention is the use of a low relatively low torque, high speed motor, coupled to transmission power component type to provide the initial kinetic energy and torque for continuous motion to the input drive unit of the input drive system to produce a large output drive force and speed at the output of the hydraulic system to drive the output systems to generate electricity.

Another future of the embodiment of the present invention is taken advantage of mechanical advantage seen at input drive system where a relatively low torque high speed motor drives a transmission power component to produce a relatively higher torque or force, which is further multiplied at the hydraulic system to produce a high pressure hydraulic fluid force to drive a paddle wheel at the output transmission system, to convert the high hydraulic pressured fluid to mechanical motion and power. The paddle wheel further increases the speed and develop torque in respond to the tangential force impinging on the outer blade of the paddle wheel. The torque produced is further multiplied at the transmission shaft due the ratio of the paddle wheel diameter to that of the transmission shaft diameter to produce a torque higher than that of generator and input drive unit to produce electricity that is several times higher than the external load design requirement and a portion of the output power produced, is fed back to power the input motor and auxiliaries.

An alternative preferred embodiment of the present invention is the use of Selector in FIG. 1 to select at least one transmission power component as an input drive unit, an example is the electro Mechanical Press configured to deliver power to the hydraulic system of the present embodiment as in FIG. 1 or directly to the output transmission system as shown in FIG. 2

Most of the transmission power component chosen are known to deliver several kilowatts of equivalent mechanical power as a unit or in combination.

The Electronic control system, could be but not limited to a variable frequency drive, an electronic switch and monitoring and control devices that could adjust the motor output speed and torque in response to variation of the alternator output speed. The rated full-load speed of the motor drive is preferably 40-70 percent, more particularly about 50 percent, of the rated no-load speed.

### BRIEF DESCRIPTION OF THE DRAWINGS

Some of the key attributes of the invention will be described in more detail in the text and illustrated in the drawing, in which:

FIG. 1 shows a Block diagram of a self-driven electric generator apparatus with the transmission components and a Selector.

FIG. 2 shows a Block diagram of a self-driven electric generator apparatus, with transmission power components without the hydraulic system of FIG. 1.

FIG. 3 shows a pictorial drawing of the elements of a self-driven electric generator apparatus of FIG. 1.

FIG. 4 shows a pictorial drawing of the elements of a self-driven electric generator apparatus of FIG. 2.

### DETAILED DESCRIPTION OF THE INVENTION

In the following description, embodiments, variations and preferred future of the invention are explained in the detail description as example to provide an understanding to those ordinarily skilled in the art to be able to practice without some of these specific details.

The description below may reference the drawings, as block diagrams, flow chats, steps and processes or electronic data without obscure the meaning.

The detailed description is not to be interpreted as limiting the scope of the previous summary of the invention in anyway Some of the words used are to give clarity to the invention such as” input drive system, to describe activities from input drive unit such a motor plus mechanical reducer, or transmission power component, to the hydraulic system. “Assembly” or “generator drive assembly,” output transmission system may be used interchangeably with “Assembly” or system without change in its meaning for those ordinary skilled in the art.

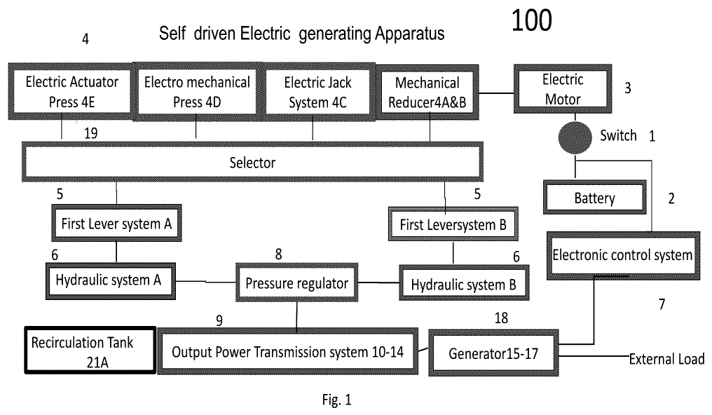

The Detail Description below may be shown as an example in one or more variation of an embodiment of the present invention. FIGS. 1-4 to gives some clarity to the description of the various embodiments.

A self-driven electric generating apparatus, more particularly the invention is an apparatus that uniquely harnesses and combines the energies of Electrical, Mechanical and Hydraulic power to produce an electric generator that produces excess power than the external load requirement and with a portion of this excess power fed back as an input power supply to the input drive unit motor and auxiliaries. For an explanation purpose the apparatus is broken down into three parts, the input drive system, output transmission system and output system.

The input drive system comprising of at least one initial power source such a battery, at least one Electric motor, when coupled to at least one compound gear train forms one transmission power component type, a converter, a First lever mechanism, a Hydraulic system, fluid recirculation tank

The output transmission system comprising of; a Paddle wheel, Flywheel, transmission shaft, gears or pulleys and belts as a minimum.

The output system comprises of; Generator and a generator drive assembly, control system, sensors, breakers and indicators, meters, and mechanical reducer (Gears and Pulleys).

A transmission power component further comprises of at least one of the following selected from a group of transmission power components; at least one electric actuator, at least one electro-mechanical press, at least one electric hydraulic press, at least one electric jack and at least one electric motor combined with a mechanical reducer; electric hydraulic pump. A mechanical reducer is made of at least one compound gear train.

A transmission power component output could either be rotational, linear or Oscillatory depending on those ordinarily skilled in the prior art. The electric motor plus mechanical reducer of the transmission power component type shall be used to explain the working of the first part of the preferred embodiment of the present invention with a rotational motion output and an electric jack of the transmission power component type with a linear output shall be used in the second part to explain the working another variation of the preferred embodiment of this invention.

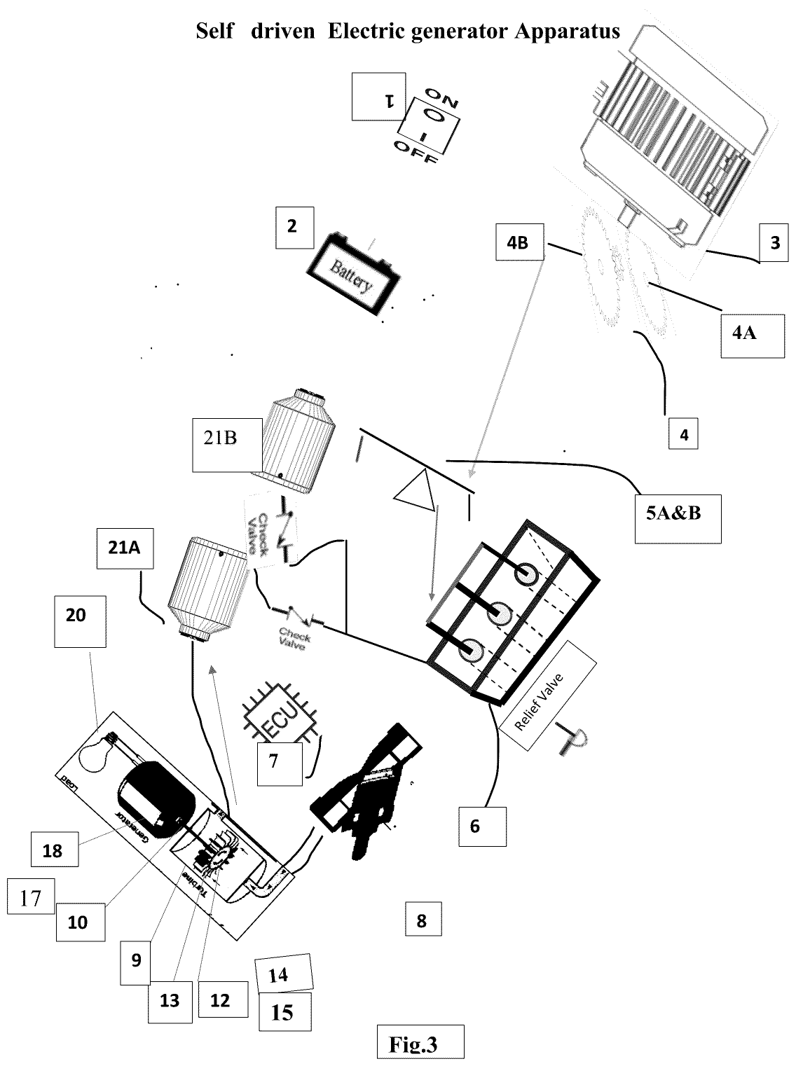

With Reference to FIGS. 1 and 3. of the self-driven electric generating apparatus, the start switches 1 is a manual switch for initiating and isolating power from the apparatus. when the switch is turned on, the internal power source such as a Battery 2 provides electric current to an input drive electric motor which is an integral part of a transmission power component selected from a group of transmission power components 4 comprising; at least one electric actuator, at least one electro-mechanical press, at least one electric Jack, at least one electric hydraulic pump, and at least one electric motor combined with a mechanical reducer; to provides continuous motion to the Apparatus at specific torque and speed.

The input drive unit electric motor 3. which could be a Universal, AC or DC motor, coupled to a transmission power component 4 (mechanical reducer) type configured to have clockwise and anti-clockwise rotational output 4A&B as shown in FIG. 3. and further configured via converter to a first liver mechanism 5 to convert the rotational motion to oscillatory motion and to cause the first lever mechanism to have an up and down movement, to further provide increase torque at low speed or Force to change the directional movement of the input arm of the hydraulic system 6 to produce a high-pressure hydraulic fluid at the output of the hydraulic system to a paddlewheel in the output transmission system. The hydraulic system input arm is connected via a loosely coupled link to the first lever arm 5 A&B. The operation is such that when one arm rotates in a clockwise direction the second arm rotates in an anticlockwise direction. The rotary motion of 4 A&B upon conversion to oscillatory motion at the first lever Mechanism 5 A&B, further multiplies the torque if desired, and creates a pumping action motion at the input arm of the input hydraulic cylinder of the hydraulic system 6, thereby effectively turning the cylinder into a mechanical hydraulic pump. when the stroke of the input hydraulic cylinder piston is in a compression mode, a large force is produced at the hydraulic system output due to the area ratio difference between the input cylinder and output cylinder of the hydraulic system. The force produced causes a high-pressured fluid to be transmitted to the output transmission system 9 through the pressure regulator 8 or spring valve embedded inside the hydraulic system output cylinder to a paddle wheel on the transmission shaft that converts the hydraulic fluid motion to a mechanical power and motion at the output transmission system 9 to drive a generator drive assembly to generate electric power that is in excess of its external load requirement and a portion of the excess power is fed back to power the input drive units and auxiliaries The pressure regulator maintains the pressure within the hydraulic system to be fairly constant. The de-energised fluid from 9 in FIG. 1 flows to a recirculation tank connect to the suction of the hydraulic system input arm via a check valve to replaced displaced fluid during the suction mode.

The output transmission system 9 consist essentially of Power transmission shaft 10, flywheel 12, Paddle wheel 13, a Gear or pulley system 14 used only if 10 is not directly coupled to the generator.

The output transmission system could be coupled to the generator drive assembly directly if it obtains sufficient force and speed from the hydraulic system or via a belt or meshed tooth Gear 14 to the output systems.

The output system consists essentially of: a generator drive assembly 15, made up of Gears or Pulleys 16 or combination; generator drive shaft 17 and the generator 18. The purpose of the gears or pulleys in both the output transmission shaft and the output system generator drive assembly is to facilitate, power transmission, speed reduction or increase to meet the generator specification.

When the high-pressured fluid from the hydraulic system impinges on the paddle wheel, it exerts a force on the paddle wheel which turns all units within the output transmission system 10-14, Torque, speed and Kinetic energy is transmitted from output transmission system to the generator either by direct coupling; via belt pulley or toothed gear 14 and 16 respectively mounted on both transmission shaft and the Generator drive shaft with the shafts sitting on bearings to support the shafts to reduce friction of rotation, to generate electrical power.

The power generated is in excess of the external load requirement, hence a portion could be fed through an electronic control system 7 to supply power to the input motor, recharge the battery and other auxiliaries.

The main driving torque comes from the hydraulic system, in this embodiment the hydraulic system has plurality of hydraulic cylinder but we shall use two hydraulic cylinder units 6A and 6B for explanation purpose, when Rods of cylinder unit 6A are on the downwards stroke or operating in compression mode, The Rods in cylinder unit 6B would be retracting upwards and be operating in the suction mode.

A hydraulic cylinder unit is made of a combination of multiple cylinders; each cylinder has corresponding plungers or rod. Depending on the implementation requirement, these cylinders are paired in such a way to be able to displace a given volume of fluid per stroke such that the volume displaced to the transmission system will be able to cause the paddle wheel to turn at least 360° turn per stroke. The output transmission is able achieve continuous 360° rotation at the design torque and speed because, coupled to the output shaft of the transmission power components are two arms 4A and 4B. each turning in reverse direction to one another and are coupled to a converter (linkage) configured to the input arms of first lever system 5A & 5B respectively as shown in FIGS. 1&3. The converter converts the Rotary motion of the transmission power components to Oscillatory motion.

The output arms of the first lever mechanism are also coupled to the input arms of the hydraulic cylinder unit 6A and 6B, and the Oscillatory movement of the lever arm causes the input arm of the hydraulic system to move up and down in a compression and retraction mode thus displacing fluid during the compression stroke and taking in fluid during the suction mode.

A continuous hydraulic high-pressure fluid is constantly been delivered to the Paddle wheel as a result of alternative pumping action of hydraulic system 6A and 6B. when one is on compression mode, the other is on the suction mode vice visa. wherein the paddle wheel which sit at the output transmission system converts the hydraulic high-pressured fluid to mechanical motion and power; and
wherein the output transmission shaft hosting the paddle wheel and generator drive assembly shaft sits on plurality of bearings at both ends of the shaft to support the shafts to reduce the friction of rotation; and
wherein paddle wheel further increases the speed and torque at the transmission shaft in proportion to the tangential force impinging on the outer blade of the paddle wheel from the hydraulic system to meet the generator torque and speed specification; and
wherein the torque produced at paddle wheel is further multiplied at the transmission shaft due to the ratio of the paddle wheel diameter to that of the transmission shaft diameter to produce a torque that is higher than that of generator and input drive unit to produce electricity that is several times higher than the external load design requirement and a portion of the output power produced, is fed back to power the input motor and auxiliaries at the required torque and speed. The check valves not labelled in FIG. 3 prevents a flow back to the recirculation tank 21A during the compression stroke and the tanks also receives the de-energised fluid from the output transmission system for circulation to hydraulic input unit during the suction mode.

The output transmission system and the generator drive mechanism could be implemented either by direct coupling, Gear to Gear or via pulley belts or combination of both systems but not limited to these methods of coupling. For example, the belt pulley 14 at the end of the transmission stage may be coupled to the generator rotor shaft pulley 16 to meet the speed/torque requirement of the generator.

In all the preferred embodiment of the present invention, a cooling system is configured to ensure that the input drive electric motor and the electronic circuitry temperatures are maintained.

The electronic control system 7 performs the function of switching, monitoring and control. It could adjust the motor output speed and torque in response to variation of the alternator output load speed. At steady state the battery power is disconnected and the electric motor connected to generator main supply. It also performs monitor and shut down functions for some predetermined parameters for the safe running of the generator.

The electric motor could be powered via a battery, solar or any electric source of appropriate rating. Where an A/C motor is used, a Kickstarter or battery plus inverter combination may be incorporated for initial starting of the system to generated power if the electric motor 3 derives its main running power from the Generator 18.

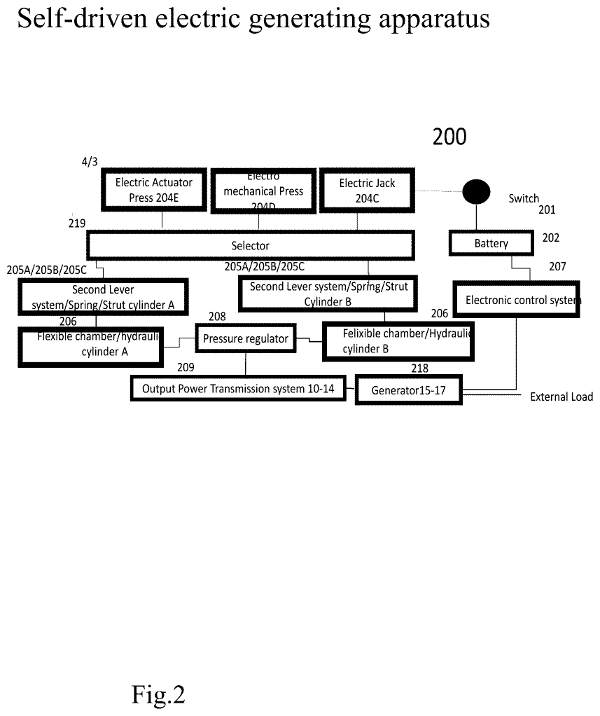

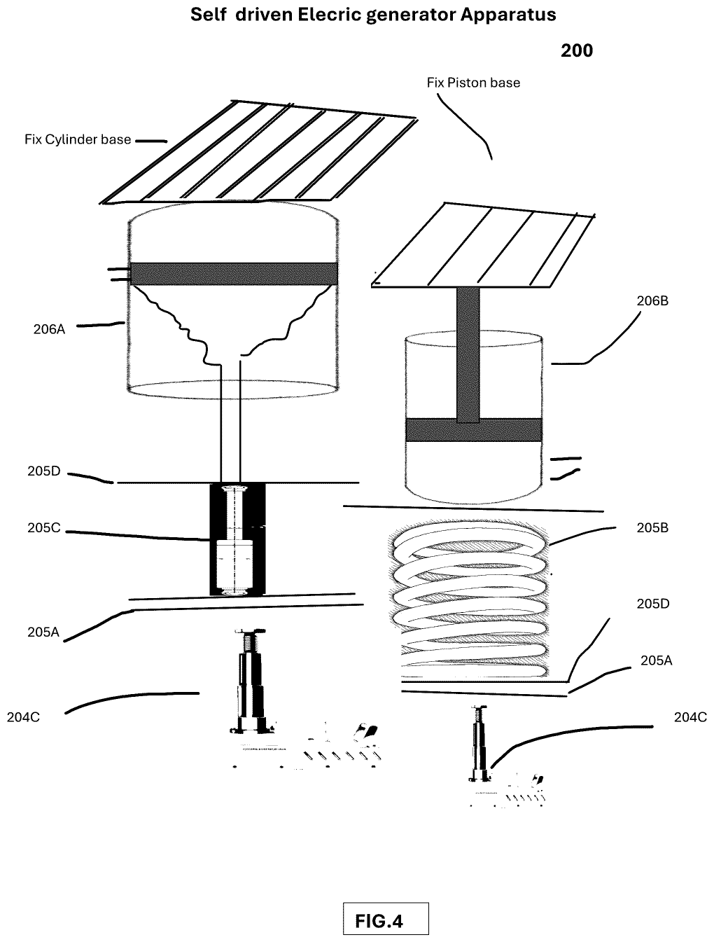

To further explain the preferred embodiment of the self-driven electric generating apparatus of the present invention, Reference FIG. 2 and FIG. 4, comprising, a transmission power component-an electric hydraulic jack system 204C; a lever mechanisms 205A; a strut cylinder 205C border by movable plates 205D with a rod that slips in out of a rigid cylinder; in contact with one end of a compressible flexible chamber rod housed in the rigid cylinder container with the wide base end of the compressible flexible chamber fixed to the rigid cylinder container 206A or a spring 205B border by moveable plates 205D; in contact with the cylinder end of a piston and rod unit 206B; and further comprise: a switch 201; a battery 202; an electronic control unit 207; output transmission system 209; output systems 218; a selector 219.

The transmission power component an electric Jack 204C is selected as the input drive unit as reference in FIGS. 2&4, when switch 201 is turn on, the electric jack receives initial power from a battery 202 outputs a mechanical power to subjects one end of the second lever mechanism 205A, in series contact with a string 205B or strut cylinder 205C bordered in a movable plates, in contact with one end of a compressible flexible chamber rod housed in the rigid cylinder container with the wide base end of compressive flexible chamber fixed to the rigid cylinder container 206A or a spring 205B border by moveable plates 205D; in contact with the cylinder end of a piston and rod unit held to a fix base; and the compressible flexible chamber filled with an incompressible fluid to compression with the spring or strut cylinders tube held in high potential energy state when the outlet valves, the pressure regulator are closed and when the fluid attains the pressure regulator set pressure, the valve opens to let out a high-pressured hydraulic fluid and kinetic energy to the output transmission system 209 to drive the generator assembly to generate excess electricity to power external load and feeds a portion the power back to power the input drive units and axillaries as earlier described in other embodiment of this invention.

The design is such that when the electric jack arm extended it outputs a mechanical force that causes an arm of a lever mechanism 205A to fully compresses a pre-calibrated spring 205B or Strut cylinder 205C against a compressible flexible chamber 206A &B filled with an incompressible fluid, the electric jack movement will momentarily stop, when the spring or strut cylinder is fully compressed against compressible flexible chambers with incompressible fluids 206A &B to a high potential energy state and will start to proportionally releases its potential energy as the cylinder 206A or B begins to output its fluid content.

The spring 205A & B are calibrated to be completely relaxed when the flexible chamber fluid in 206A is empty. The high-pressured Fluid from the chamber is transformed at the paddle wheel of the output transmission system 209 to mechanical power and motion at the output transmission shaft to drive a generator drive assembly to generate electric power that is in excess of its external load requirement and feeds a portion of the excess power back to power the input drive units and auxiliaries

The preferred embodiment of the self-driven electric generating apparatus of the present invention claims benefit of the output transmission system and output system to generate electric power in their implementation as detailed in the preferred embodiment of FIG. 1. to meet the design requirement and power itself.

A future of this embodiment is that the spring and the strut cylinders are designed to meet potential energy requirement and also have capability to release its stored energy at predetermined rate that corresponds to cylinder's working height from full to empty which is equivalent to the fluid working height of cylinder 206B.for example if a cylinder has a liquid head room of 6 inches, the strut or the spring should have an equivalent solid height of 6 inches.

When the compressible flexible chamber 206A or cylinder and piston 206B are at their compression end, the electric Jack causes the second lever mechanism to changes direction and pulls the springs 205A and strut cylinder 205B back to their initial position before compression.

This action causes the chamber and cylinders to be in a suction mode as the chambers will be in a partial vacuum to receive fluid from the recirculation tank for the next cycle begins.

The electronic control system 7 of FIG. 1 benefit is claimed in implementing this preferred embodiment of the electric jack system as 207 in FIG. 2 to performs the function of switching. monitoring and control. It could adjust the Jack motor movement in response to variation of the alternator output load speed. At steady state the battery power is disconnected and the electric motor connected to generator main supply. It also performs monitor and shut down functions for some predetermined parameters for the safe running of the generator Other common unit are the output transmission and output systems of the preferred embodiment.

A further preferred embodiment of a Self-driven electric power generating apparatus of the present invention compressing; transmission power components-an electro-mechanical press system consists essentially of: an electric motor, a flywheel and compound gears, clutch and crank drive, it may be implemented with some modification by following the description given for other preferred embodiment in FIGS. 1-4 by replacing the electric jack or mechanical reducer with the electro-mechanical press as the preferred transmission power component input drive and implement by claiming the benefit as described either in FIG. 1 or FIG. 2, to generate electric power that is in excess of its external load requirement and feeds a portion of the excess power back to power the input drive units and auxiliaries

Reference FIGS. 1-4 A further preferred embodiment of a Self-driven electric power generating apparatus of the present invention compressing; transmission power components-Electric Actuator consists essentially of an electric motor, Gears box, Rack and Pinion, housing and end cap. it may be implemented with some modification depending on the intention of those ordinarily skill in art without deviation from intent of the present invention.

Reference to FIGS. 1&2. the Electric actuator replaces the other transmission power component as an input drive and implement by claiming the benefit detailed in FIG. 1 or FIG. 2. as described and works without deviation from the intent of the present invention to meet the input drive system requirement and to produce electric power that is in excess of its external load requirement and feeds a portion of the excess power back to power the input drive units and auxiliaries

Each section of this invention could be housed either in steel, plastic, cast or vacuum enclosure or opened, depending on intent of those knowledgeable of the prior art to increase efficiency and minimise noise, air resistance or to enhance any of the futures.

The flywheel could be housed in a vacuum chamber, reduced air enclosure or open. The shafts could be stainless steel or steel that meets generator specification, the Lever mechanism could be a steel, plastic, wood, aluminium bar or any other material of appropriate specification.

1. A Self-driven electric power generating apparatus comprising:
a manual start switch configured to initiate or isolate the electrical power generation system;
an internal energy source configured to supply initial power to the input drive systems having at least one transmission power component selected from a group of transmission power components and output system;
a one or more alternative power sources selected from the group consisting of a solar panel and inverter, domestic power, and grid power;
an external power source configured as alternative power source in the absence of the internal power source to initial power to the input drive unit and control system having at least one transmission power component selected from a group of transmission power components and output systems;
a group of transmission power component comprising, at least one electric actuator, at least one electro-mechanical press, at least one electric Jack, at least one electric hydraulic press, and at least one electric motor coupled to a mechanical reducer; at least on electric hydraulic pump; to provides continuous motion and power to the Apparatus at Specific torque and speed;
an electric motor coupled to a mechanical reducer selected from the group of transmission power component to produce mechanical energy and motion the input drive system;
an electric motor configured of producing mechanical energy to drive a mechanical reducer;
a mechanical reducer configured to producing large Torque at low speed when compared with the input motor and generator torque and speed configured to the first lever mechanism via the converter, wherein the mechanical reducer is a compound gear train that produces a rotary output;
a converter configured to the output of the mechanical reducer and the input of the first lever mechanism to convert the output of the mechanical reducer from rotational to oscillation;
a first level mechanism is coupled via link to at least one transmission;
component converter to deliver torque and speed to the input end of the first lever mechanism;
a first lever mechanism configured to further multiply or divide the torque from the transmission component; and converting a rotary or reciprocating motion to oscillatory motion to drive the hydraulic system input pump arm unit;
a hydraulic system comprising;
a plurality of hydraulic cylinders and pistons and rods; configured to maintain the fluid pressure and converting the hydraulic energy to motion; and transferring motion to a larger area cylinder to generate mechanical force at the output of the hydraulic system to drive the paddle wheel;
a plurality of the hydraulic cylinders capable of displacing sufficient volume fluid per stroke to meet the output drive requirements;
a pressure regulator or a spring valve to maintain pressure within the hydraulic system;
a fluid tank configured to store and replenish displaced fluid to the hydraulic system;
a check valves configured to allow flow in one direction and prevent blow back within the hydraulic system;
a Pressure relief valve capable of protecting over pressurisation of the hydraulic system;
a cooling system configured to maintain the temperature of the components within the power generation system;
a paddle wheel configured to convert the high-pressure hydraulic fluid force to a turning force and mechanical power;
a flywheel configured to store energy and smoothing power output of the apparatus;
a power transmission shaft configured to hosts the output drive mechanisms and transmits motion power directly to the generator or via connected gears or pulley belts;
a generator coupled to the power transmission shaft to generate electric power that is in excess of its external load requirement and feeds a portion of the excess power back to power the input drive units and auxiliaries;
an electronic control unit comprising; circuits that performs, switching, monitoring, controlling and shutdown functions, and at steady state disconnects the battery and allow a portion of the main power from the generator to be switched to the input drive motor and auxiliaries and disconnect the battery and other power source;
a fluid tank configured to receive de-energised fluid from the output transmission and replenish displaced fluid in the hydraulic system.

2. a Self-driven electric power generating apparatus according to claim 1, wherein the paddle wheel at the output transmission system converts the hydraulic high-pressured fluid to mechanical motion and power; and
wherein the output transmission shaft hosting the paddle wheel and generator drive assembly shaft sits on plurality of bearings at both end of the shafts to support the shafts to reduce the friction of rotation; and
wherein paddle wheel further increases the speed and torque at the transmission shaft in proportion to the tangential force impinging on the outer blade of the paddle wheel from the hydraulic system to meet the generator torque and speed specification;
wherein the torque produced at paddle wheel is further multiplied at the transmission shaft due to the ratio of the paddle wheel diameter to that of the transmission shaft diameter to produce a torque higher than that of generator and input drive unit to produce electricity that is several times higher than the external load design requirement and a portion of the output power produced, is fed back to power the input motor and auxiliaries.

3. a Self-driven electric power generating apparatus according to claim 1, wherein the internal power source is a battery configured to supply initial power to the direct current electric motor; wherein the internal power source is a battery connected to an inverter to convert the direct current power to an alternating current (ac) to drive an electric motor if mechanical reducer is driven by an ac electric motor;
wherein included is a battery recharging unit, configured to recharge the battery while electrical power is being received from the electric generator or the external power source;
Wherein further included are one or more alternative power sources selected from the group of external power source consisting of a solar panel and inverter, domestic power, and grid power;
Wherein the control circuit configured to select the initial start power supply and to switch to any of the alternative power sources from the alternative power source when required;
wherein the control circuitry is further configured to monitor and control set parameters such temperature, pressures, shut down, battery, settings and voltages and initiate appropriate commands to ensure safety operation of the generator.

4. a Self-driven electric power generating apparatus according to claim 1 the group of transmission power component comprising of: at least one electric actuator; at least one electro-mechanical press; at least one electric Jack; at least one electric hydraulic pump; and at least one electric motor configured to a mechanical reducer; at least on hydraulic pump; to provides continuous motion and power to the Apparatus at a specific torque and speed;
wherein the at least one or a combination of the transmission power component from the group could be selected to deliver mechanical energy via the converter to the first lever mechanism to drive the hydraulic system;
wherein the output of the at least one or a combination of the transmission power component selected from the group could be either linear or rotary or oscillation and configured to a first lever mechanism via converter; to drive the hydraulic system;
wherein the converter can be a rotational to oscillatory; or rotational to linear; and electro mechanical converter used relation to the transmission power component output type.

5. a Self-driven electric power generating apparatus according to claim 1; wherein the hydraulic system configured to deliver a hydraulic power to an output transmission system further includes a plurality of the hydraulic cylinders configured to displacing sufficient volume of fluid per stroke to meet the output transmission system requirements.

6. a Self-driven electric power generating apparatus configured to generate electric power comprising:
an electric hydraulic jack system configured to store potential energy into a spring or a strut cylinder, held between two moveable plates and in contact with the plate of a compressible flexible chamber or cylinder end of a piston and rod unit;
wherein a rod is attached to one end of the compressible flexible chamber and the other of the chamber is held in a rigid cylinder container allowing compression and retraction when the rod moves in a linear formation;
a second lever mechanism in contact with both the electric jack and one end of the movable plate housing the springs for changing the direction of motion of the springs or strut cylinder;
an electric jack for storing potential energy into the springs held in contact with the plates of a compressible flexible chamber and cylinder end of a piston and rod unit;
a spring or strut cylinder in a moveable plate in contact with both the jack and the springs or strut cylinder for storing potential energy;
a compressible flexible chamber filled with incompressible fluid in contact with the spring or strut cylinder and pressure regulator, storing the fluid in a high potential energy state;
an output transmission system configured to receive high-pressured hydraulic fluid from the compression flexible chamber cylinder and convert to mechanical motion to drive the generator to produce power;
a paddle wheel configured to convert the high-pressure hydraulic fluid force to a turning force and mechanical power;
a flywheel configured to store energy and smoothing power output of the apparatus;
a power transmission shaft configured to hosts the output drive mechanisms and transmits motion power directly to the generator or via connected gears or pulley belts;
a generator coupled to the power transmission shaft to generate electric power that is in excess of its external load requirement and feeds a portion of the excess power back to power the input drive units and auxiliaries;
a fluid tank configured to receive de-energised fluid from the output transmission and replenish displaced fluid in the in the compressible flexible chamber or cylinder housing piston and rod;
an electronic control unit comprising; circuits that performs, switching, monitoring, controlling and shutdown functions, and at steady state disconnects the battery and allow a portion of the main power from the generator to be switched to the input drive motor and auxiliaries and disconnect the battery and other power source;
a cool system configured to maintain the temperature of the components within the power generation system.

7. a Self-driven electric power generating apparatus according to claim 6, wherein the electric jack system is configured to engage a second lever mechanism and string mechanism to subject the compressible flexible chamber container or cylinder end of a piston and rod unit to a high potential energy state;
Wherein the compressible flexible chamber comprises: a rod fitted to one end of the compressible flexible chamber and the second end held to rigid container so as to allow the rod to move in compression and retraction mode;
wherein the strut cylinder compresses a piston and rod that slips in and out of a pressurised sealed cylinder to stored potential energy and release on demand;
wherein the electric power generated is in excess of its external load requirement and feeds a portion of the excess power back to power the input drive units and auxiliaries.

8. a Self-driven electric power generating apparatus according to claim 6, Wherein the control system circuit configured to select the initial start power supply and to switch to any of the alternative power sources from the alternative power source when required; wherein the control circuitry is further configured to monitor and control set parameters such temperature, pressures, shut down settings and voltages and initiate appropriate commands to ensure safety operation of the generator.

9. a Self-driven electric power generating apparatus that generate sufficient electricity to meet the electricity needs of domestic homes, cottage industries, small industries and powers its input drive units, control systems and auxiliaries.
